(19) United States
(12) Patent Application Publication
(10) Pub. No.: US 2010/0213823 A1
(43) Pub. Date: Aug. 26, 2010

(54) INORGANIC ELECTROLUMINESCENT DEVICE

(75) Inventors: Tae-won JEONG, Yongin-si (KR); Seong-eui LEE, Siheung-si (KR); Shang-hyeun PARK, Yongin-si (KR); Min-jong BAE, Yongin-si (KR)

Correspondence Address: CANTOR COLBURN, LLP, 20 Church Street, 22nd Floor, Hartford, CT, 06103, US

(73) Assignees: SAMSUNG ELECTRONICS CO., LTD., Suwon-si (KR); KOREA POLYTECHNIC UNIVERSITY INDUSTRY ACADEMIC COOPERATION FOUNDATION, Siheung-si (KR)

(21) Appl. No.: 12/712,557

(22) Filed: Feb. 25, 2010

(30) Foreign Application Priority Data
Feb. 25, 2009 (KR) 10-2009-0015871

(51) Int. Cl. H01J 1/62; H01J 9/00

(52) U.S. Cl. 313/503; 313/509; 445/23

(57) ABSTRACT

An inorganic electroluminescent device includes; a lower electrode, a dielectric layer which is disposed on the lower electrode and includes a low dielectric material layer and a high dielectric material layer, an inorganic light emitting layer disposed on the dielectric layer, and an upper electrode disposed on the inorganic light emitting layer, wherein the low dielectric material layer has a greater dielectric constant than the high dielectric material layer.

### CROSS-REFERENCE TO RELATED APPLICATION

This application claims priority to Korean Patent Application No. 10-2009-0015871, filed on Feb. 25, 2009, and all the benefits accruing therefrom under 35 U.S.C. §119, the content of which in its entirety is herein incorporated by reference.

### BACKGROUND

1. Field

One or more embodiments of the present invention relate to an inorganic electroluminescent device, and more particularly, to an inorganic electroluminescent device which includes a high dielectric material layer and a low dielectric material layer, and thus prevents crosstalk between cells.

2. Description of the Related Art

An inorganic electroluminescent device (hereinafter, referred to as an “inorganic EL”) is used as a lamp type light source, and may be used in a keypad of a mobile phone, a billboard, simple medical instruments, or other similar applications.

As sizes of displays increase, and the display requirements of consumers become more diversified, digital information displays (“DIDs”), home displays, and other display apparatus are accordingly attracting increased attention. Interest in inorganic ELs that are very thin, flexible, and have low cost as compared to other displays is increasing. Accordingly, studies are being conducted into the application of inorganic ELs in various fields.

An inorganic EL may be generally classified into a thin film type and a power type (also referred to as a dispersed type). The thin film type has a distinct threshold voltage during operation, and thus studies have been conducted into the application of the thin film type of inorganic EL in a display utilizing a passive matrix (“PM”) drive. Meanwhile, the dispersed type of inorganic EL does not have a distinct threshold voltage, and thus when driven according to the passive matrix driving technique, pixels which are adjacent to the pixel which was intended to be driven emit unwanted light. Accordingly, the dispersed type of inorganic EL is typically used as a lamp type light source, without being implemented as a display. In other words, the dispersed type inorganic EL is mainly used in a keypad of a mobile phone, a billboard, simple medical instruments, or other similar apparatus. Consequently, studies into improving application possibilities of dispersed type inorganic ELs in various fields are required.

### SUMMARY

One or more embodiments include an inorganic electroluminescent device that suppresses light emission of pixels around a selected pixel.

Additional aspects will be set forth in part in the description which follows and, in part, will be apparent from the description, or may be learned by practice of the presented embodiments.

According to one or more embodiments, an inorganic electroluminescent device includes; a lower electrode, a dielectric layer which is disposed on the lower electrode and includes a low dielectric material layer and a high dielectric material layer, an inorganic light emitting layer disposed on the dielectric layer and an upper electrode which is disposed on the inorganic light emitting layer, wherein the low dielectric material layer has a greater dielectric constant than the high dielectric material layer.

In one embodiment, electric field permittivity of the high dielectric material layer may be greater than electric field permittivity of the low dielectric material layer.

In one embodiment, the high dielectric material layer may be selected from the group consisting of lead magnesium niobate (Pb(Mg1/3Nb2/3)O3) (“PMN”), lead nickel niobate (Pb(Ni1/3Nb2/3)O3) (“PNN”), barium titanate (BaTiO3), strontium titanate (SrTiO3) and combinations thereof.

In one embodiment, the low dielectric material layer may be selected from the group consisting of a glass paste, a silicon oxide, a silicon nitride and combinations thereof.

In one embodiment, the inorganic light emitting layer may include inorganic phosphor.

In one embodiment, the inorganic phosphor may be selected from the group consisting of zinc sulfide (ZnS), strontium sulfide (SrS), barium sulfide (BaS), gallium sulfide (GaS), zinc oxide (ZnO), zinc selenide (ZnSe), gallium nitride (GaN), gallium phosphide (GaP) and combinations thereof.

In one embodiment, the lower electrode may extend in a first direction, the upper electrode may extend in a second direction disposed substantially oblique to the first direction, and the high dielectric material layer may be disposed on an area where the lower electrode and the upper electrode are vertically aligned.

### BRIEF DESCRIPTION OF THE DRAWINGS

These and/or other aspects will become apparent and more readily appreciated from the following description of the embodiments, taken in conjunction with the accompanying drawings of which:

FIGS. 1 and 2 are diagrams of an embodiment of an inorganic electroluminescent device;

FIG. 3 is a graph showing brightness change characteristics of an embodiment of an inorganic electroluminescent device (illustrated by the line “HD+LD”), which includes a dielectric layer including a low dielectric material layer formed of glass paste and a high dielectric material layer formed of Pb(Mg_{1/3}Nb_{2/3})O₃ (“PMN”), and an inorganic electroluminescent device (illustrated by the line “HD”) including a dielectric layer formed of PMN;

FIGS. 4A and 4B are graphs respectively showing embodiments of voltage waveforms of an embodiment of an inorganic electroluminescent device including a dielectric layer formed of materials having different permittivities, and an inorganic electroluminescent device including a dielectric layer formed of a material having a high permittivity; and

FIGS. 5A and 5B are graphs respectively showing embodiments of current waveforms of an embodiment of an inorganic electroluminescent device including a dielectric layer formed of materials having different permittivities, and an inorganic electroluminescent device including a dielectric layer formed of a material having a high permittivity.

### DETAILED DESCRIPTION

Embodiments now will be described more fully hereinafter with reference to the accompanying drawings, in which embodiments are shown. These embodiments may, however, be embodied in many different forms and should not be construed as limited to the embodiments set forth herein. Rather, these embodiments are provided so that this disclosure will be thorough and complete, and will fully convey the scope of the disclosure to those skilled in the art. Like reference numerals refer to like elements throughout.

It will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the present invention.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another elements as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower”, can therefore, encompasses both an orientation of “lower” and “upper,” depending on the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments should not be construed as limited to the particular shapes of regions illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the disclosure.

All methods described herein can be performed in a suitable order unless otherwise indicated herein or otherwise clearly contradicted by context. The use of any and all examples, or exemplary language (e.g., “such as”), is intended merely to better illustrate the disclosure and does not pose a limitation on the scope thereof unless otherwise claimed. No language in the specification should be construed as indicating any non-claimed element as essential to the practice of the embodiments as used herein.

Hereinafter, the embodiments will be described in detail with reference to the accompanying drawings.

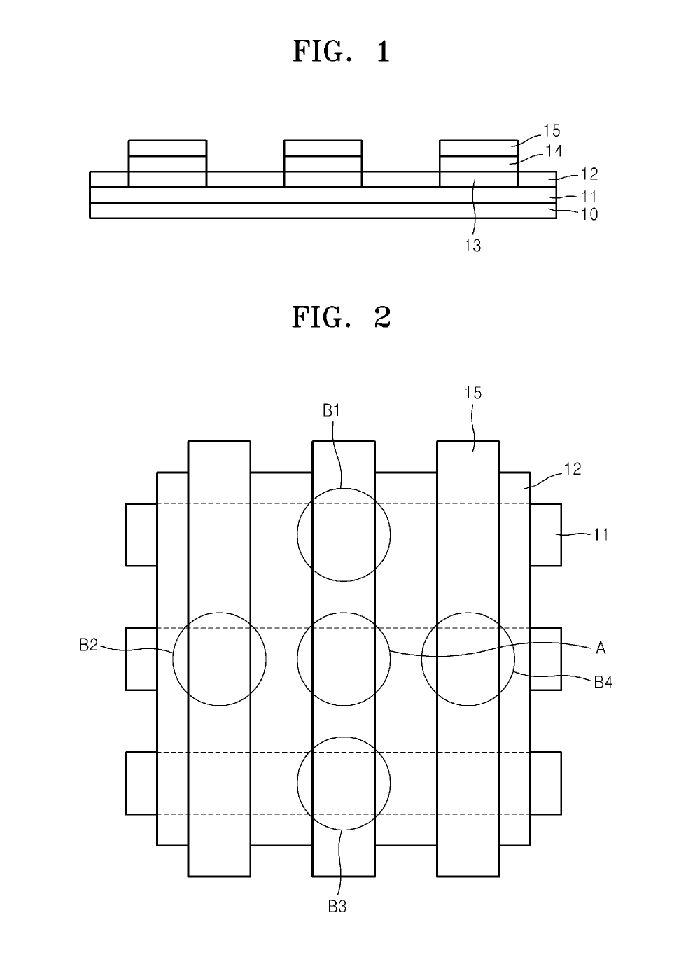

FIGS. 1 and 2 are diagrams of an embodiment of an inorganic electroluminescent device.

Referring to FIGS. 1 and 2, a lower electrode 11 is formed on a substrate 10, and a dielectric layer is formed on the lower electrode 11. Here, the dielectric layer includes a low dielectric material layer 12 including a material having a low dielectric material, and a high dielectric material layer 13 including a material having a high dielectric material. An inorganic light emitting layer 14 is formed on the high dielectric material layer 13, and an upper electrode 15 is formed on the inorganic light emitting layer 14. In the present embodiment, the high dielectric material layer has a greater electric field permittivity, and therefore a lower dielectric constant, than the low dielectric material layer.

The lower electrode 11 and the upper electrode 15 cross each other with the dielectric layers 12 and 13 and the light emitting layer 14 disposed therebetween, e.g., in one embodiment they are disposed substantially perpendicular to one anther. For example, in one embodiment the lower electrode 11 has a pattern structure wherein a plurality of lines are formed in a first direction, and the upper electrode 15 has a pattern structure wherein a plurality of lines formed in a second direction oblique to the first direction. In the present embodiment of an inorganic electroluminescent device, the high dielectric material layer 13 may be formed in an area where the lower electrode 11 and the upper electrode 15 cross each other, e.g., in an area where the lower electrode 11 and the upper electrode 15 are vertically aligned. The area where the high dielectric material layer 13 is disposed may be referred to as a cell area. In such an embodiment, the low dielectric material layer 12 may be formed between cells. In one embodiment, the dielectric material layer 13 may be formed of a material having higher electric field permittivity (hereinafter referred to simply as “permittivity”) than the low dielectric material layer 12.

Materials for forming each layer of the current embodiment of an inorganic electroluminescent device as shown in FIGS. 1 and 2 will now be described.

Embodiments of the substrate 10 may be formed of a transparent material, embodiments of which may include glass, plastic or other materials having similar characteristics. In such an embodiment, an upper substrate (not shown) may be additionally formed on the upper electrode 15. The upper substrate may be formed of a transparent material similar to the substrate 10.

Embodiments of the lower electrode 11 and the upper electrode 15 may be formed of a metal, a conductive metal oxide or other materials having similar characteristics. In one embodiment, the conductive metal oxide may be a transparent conductive material, such as indium tin oxide (“ITO”), indium zinc oxide (“IZO”) or other materials having similar characteristics.

The dielectric layer includes the low dielectric material layer 12 and the high dielectric material layer 13, which have different permittivities. The permittivity of the low dielectric material layer 12 and the permittivity of the high dielectric material layer 13 are relative, and in one embodiment the permittivity of the high dielectric material layer 13 may be higher than the permittivity of the low dielectric material layer 12. Embodiments of the high dielectric material layer 13 include lead magnesium niobate (Pb(Mg_{1/3}Nb_{2/3})O₃) (“PMN”), lead nickel niobate (Pb(Ni_{1/3}Nb_{2/3})O₃) (“PNN”) titanate (BaTiO₃), or strontium titanate (SrTiO₃). Embodiments of the low dielectric material layer 12 include a glass paste, a silicon oxide, a silicon nitride or other materials with similar characteristics.

In one embodiment, the inorganic light emitting layer 14 may include an inorganic phosphor. For example, in one embodiment the inorganic light emitting layer 14 may include at least one material selected from the group consisting of zinc sulfide (ZnS), strontium sulfide (SrS), barium sulfide (BaS), gallium sulfide (GaS), zinc oxide (ZnO), zinc selenide (ZnSe), gallium nitride (GaN), gallium phosphide (GaP) and other materials with similar characteristics. The inorganic light emitting layer 14 may include a red phosphor material which emits red light, a green phosphor material which emits green light and blue phosphor material which emits blue light. In the embodiment wherein the inorganic light emitting layer 14 includes phosphors, ZnS:copper (Cu), chlorine (Cl), manganese (Mn) or other materials with similar characteristics may be used as the red phosphor, ZnS:Cu, aluminum (Al), ZnS:Cu, Cl or other materials with similar characteristics may be used as the green phosphor, and ZnS:Cu, Cl or other materials with similar characteristics may be used as the blue phosphor.

An embodiment of a driving principle of the inorganic electroluminescent device will now be described.

When a voltage is applied to the lower electrode 11 and the upper electrode 15 that crosses the lower electrode 11, electrons are discharged from the high dielectric material layer 13 to the inorganic light emitting layer 14. Here, a direct current (“DC”) voltage or an alternating current (“AC”) voltage may be applied between the lower and upper electrodes 11 and 15. The electrons discharged from the high dielectric material layer 13 are accelerated by an electric field formed inside the inorganic light emitting layer 14, and collide with the red, green, and/or blue phosphors inside the inorganic light emitting layer 14. Accordingly, photons having wavelengths corresponding to red, green, and blue colors are respectively emitted from the red, green, and blue phosphors.

For example, when a voltage is applied to a cell A of FIG. 2 via the lower and upper electrodes 11 and 15, light is emitted from the cell A due to a potential difference between the two electrodes 11 and 15. However, other cells B1, B2, B3, and B4 do not emit light since the cells B1, B2, B3, and B4 are at a floating potential and thus a potential difference between the lower and upper electrodes 11 and 15 at those locations is effectively 0.

However, when the dielectric layer is formed of materials having the same permittivity, charges accumulated when the cell A emits light may move to the cells B1, B2, B3, and B4 that are adjacent to the cell A along a surface of the dielectric layer, and thus the cells B1, B2, B3, and B4 may undesirably emit light. Accordingly, a contrast characteristic of the inorganic electroluminescent device may deteriorate due to the unwanted additional light emitted from the adjacent cells B1, B2, B3 and B4.

However, in the current embodiment of an inorganic electroluminescent device, the high dielectric material layer 13 formed of a material having high permittivity is formed only in a cell area, and the low dielectric material layer 12 formed of a material having low permittivity is formed between cells. Accordingly, crosstalk between adjacent cells is prevented, thereby increasing a contrast characteristic of the inorganic electroluminescent device.

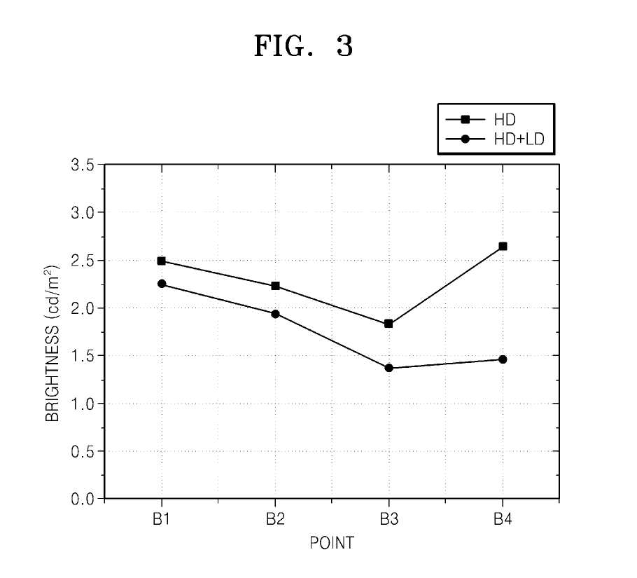

FIGS. 3, 4A, 4B, 5A, and 5B are graphs showing light emitting, voltages, and current characteristics of an inorganic electroluminescent device (illustrated along the line labeled HD+LD), which includes a dielectric layer including both the low dielectric material layer 12 formed of a glass paste and the high dielectric material layer 13 formed of PMN, and an inorganic electroluminescent device (illustrated along the line labeled HD), which includes only a dielectric layer formed of PMN.

FIG. 3 is a graph showing brightness change characteristics of the inorganic electroluminescent device (HD+LD), which includes the dielectric layer including the low dielectric material layer 12 formed of a glass paste and the high dielectric material layer 13 formed of PMN, and the inorganic electroluminescent device (HD), which includes a dielectric layer formed only of PMN. FIG. 3 shows relative brightness values of the cells B1, B2, B3, and B4 adjacent to the cell A1 of FIG. 2, when a brightness value of the cell A is 100 cd/m².

Referring to FIG. 3, the brightness values in the cells B1, B2, B3, and B4 of the inorganic electroluminescent device (HD+LD) are lower than the brightness values in the cells B1, B2, B3, and B4 of the inorganic electroluminescent device (HD). When the dielectric layer includes the low dielectric material layer 12 between cells, charge accumulated while the cell A emits light does not move to adjacent cells, and thus the cells B1, B2, B3, and B4 are suppressed from undesirably emitting light. Accordingly, a contrast characteristic of the inorganic electroluminescent device (HD+LD) may be increased.

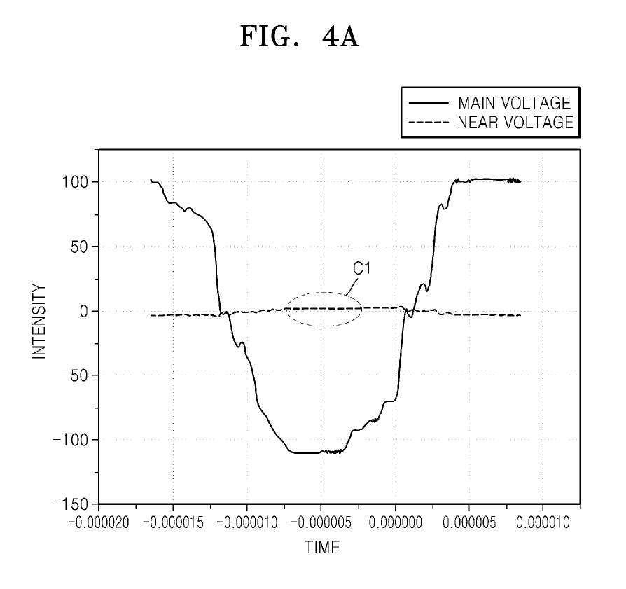

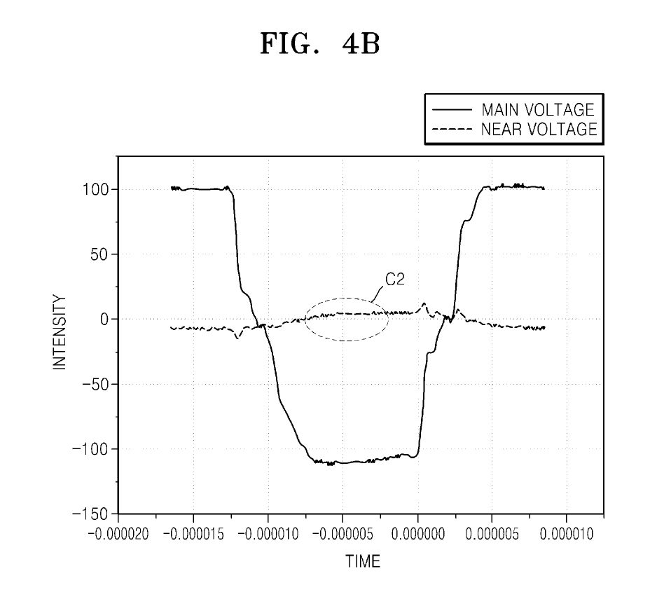

FIGS. 4A and 4B are graphs respectively showing voltage waveforms of an embodiment of an inorganic electroluminescent device including a dielectric layer formed of materials having different permittivities, and an inorganic electroluminescent device including a dielectric layer formed of a material having only a high permittivity.

Referring to FIGS. 4A and 4B, a voltage waveform in cells adjacent to a main pixel, wherein the voltage is generated by a main voltage applied thereto, is stable in a domain C1 of FIG. 4A, but is relatively unstable in a domain C2 of FIG. 4B compared to the domain C1 of FIG. 4A. A size of a voltage generated in adjacent cells may be reduced by forming the high dielectric material layer 13 having a high permittivity in a cell area, and forming the low dielectric material layer 12 having a relatively low permittivity between cells.

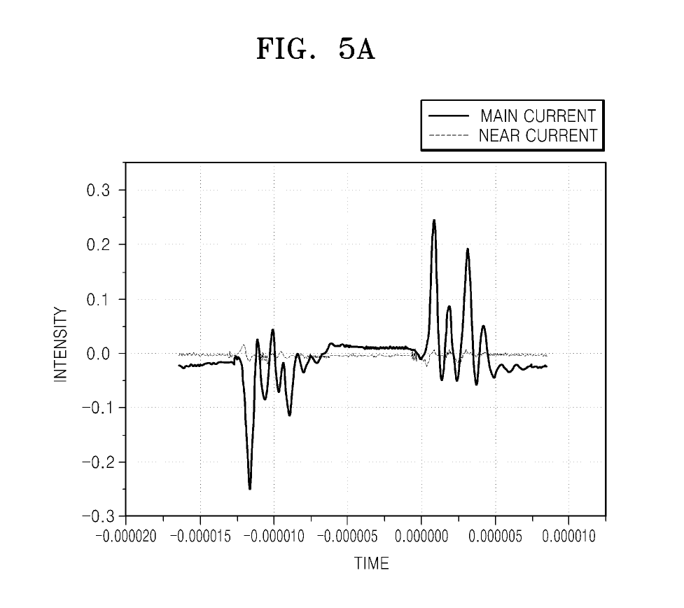

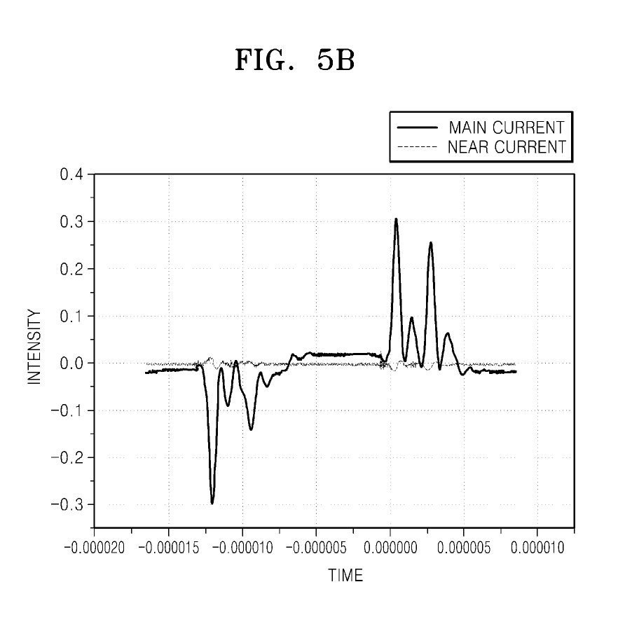

FIGS. 5A and 5B are graphs respectively showing current waveforms of an embodiment of an inorganic electroluminescent device including a dielectric layer formed of materials having different permittivities and an inorganic electroluminescent device including a dielectric layer formed of only a material having a high permittivity.

Referring to FIGS. 5A and 5B, looking at a waveform of a main current in a main pixel and a waveform of a current in cells adjacent to the main pixel, a current applied to the cells adjacent to the main pixel is larger in FIG. 5B than in FIG. 5A.

Consequently, crosstalk generated between adjacent cells is prevented since charge is prevented from flowing to adjacent cells by forming the high dielectric material layer 13 having a high permittivity in a cell area and forming the low dielectric material layer 12 having a relatively low permittivity between cells.

As described above, according to the one or more of the above embodiments, the inorganic electroluminescent device includes characteristics of a dispersed type inorganic electroluminescent device such as flexibility, low cost, and thinness, and has an increased range of applications due to its decreased cross-talk generation, which makes the embodiments candidates for applications as displays in various fields.

According to the one or more of the above embodiments, by forming a dielectric layer by using materials having different permittivities, charge generated while driving an inorganic electroluminescent device is prevented from flowing between adjacent cells, thereby preventing crosstalk. Accordingly, contrast deterioration that may occur while driving the inorganic electroluminescent device may be prevented. Consequently, a dispersed type inorganic electroluminescent device may be used as a display in various fields.

It should be understood that the exemplary embodiments described herein should be considered in a descriptive sense only and not for purposes of limitation. Descriptions of features or aspects within each embodiment should typically be considered as available for other similar features or aspects in other embodiments.

What is claimed is:

1. An inorganic electroluminescent device comprising:
a lower electrode;
a dielectric layer which is disposed on the lower electrode and comprises a low dielectric material layer and a high dielectric material layer;
an inorganic light emitting layer disposed on the dielectric layer; and
an upper electrode disposed on the inorganic light emitting layer,
wherein the high dielectric material layer has a greater dielectric constant than the low dielectric material layer.

2. The inorganic electroluminescent device of claim 1, wherein electric field permittivity of the high dielectric material layer is greater than electric field permittivity of the low dielectric material layer.

3. The inorganic electroluminescent device of claim 1, wherein the high dielectric material layer is selected from the group consisting of lead magnesium niobate (Pb(Mg_{1/3}Nb_{2/3})O₃), lead nickel niobate (Pb(Ni_{1/3}Nb_{2/3})O₃), barium titanate (BaTiO₃), strontium titanate (SrTiO₃) and combinations thereof.

4. The inorganic electroluminescent device of claim 1, wherein the low dielectric material layer is selected from the group consisting of a glass paste, a silicon oxide, a silicon nitride and combinations thereof.

5. The inorganic electroluminescent device of claim 1, wherein the inorganic light emitting layer comprises an inorganic phosphor.

6. The inorganic electroluminescent device of claim 5, wherein the inorganic phosphor is selected from the group consisting of zinc sulfide (ZnS), strontium sulfide (SrS), barium sulfide (BaS), gallium sulfide (GaS), zinc oxide (ZnO), zinc selenide (ZnSe), gallium nitride (GaN), gallium phosphide (GaP) and combinations thereof.

7. The inorganic electroluminescent device of claim 1, wherein the lower electrode extends in a first direction, the upper electrode extends in a second direction disposed substantially oblique to the first direction, and the high dielectric material layer is disposed on an area where the lower electrode and the upper electrode are vertically aligned.

8. The inorganic electroluminescent device of claim 1, wherein the high dielectric material layer is disposed only on the area where the lower electrode and the upper electrode are vertically aligned and the low dielectric material layer is disposed surrounding the high dielectric material layer.

9. A method of manufacturing an inorganic electroluminescent device, the method comprising:
providing a substrate;
disposing a plurality of lower electrodes along a first direction on the substrate;
disposing a dielectric layer including a low dielectric material layer having a first dielectric constant and a high dielectric material layer having a second dielectric constant on the plurality of lower electrodes;
disposing an inorganic light emitting layer on only the high dielectric material layer; and
disposing a plurality of upper electrodes along a second direction on the inorganic light emitting layer, wherein the second direction is substantially perpendicular to the first direction,
wherein the second dielectric constant is less than the first dielectric constant.
